(19) United States
(12) Patent Application Publication
(10) Pub. No.: US 2021/0192520 A1
(43) Pub. Date: Jun. 24, 2021

(54) DISTRIBUTED CREDIT ECOSYSTEM

(71) Applicant: Synchrony Bank, Stamford, CT (US)

(72) Inventors: Ujjval Patel, Stamford, CT (US); Justin Ruan, Stamford, CT (US); Noah Pell, Stamford, CT (US)

(73) Assignee: Synchrony Bank, Stamford, CT (US)

(21) Appl. No.: 17/124,734

(22) Filed: Dec. 17, 2020

Related U.S. Application Data
(60) Provisional application No. 62/949,363, filed on Dec. 17, 2019.

(51) Int. Cl. G06Q 20/40; G06Q 20/10; H04L 9/32; H04L 9/06

(52) U.S. Cl. CPC G06Q 20/4014; G06Q 20/102; H04L 2209/56; H04L 9/0618; H04L 2209/38; H04L 9/3218

(57) ABSTRACT

A framework is provided for an automated and distributed system including onboarding to a network utilizing a digital ledger, payment processing and settlement, and a data marketplace in which users control access to their data. The ledger is stored within a distributed architecture. The ledger includes blocks, wherein a complete copy of the ledger is stored on one or more nodes, and the ledger is capable of verifying the blocks. A credential request is provided that includes information that when received at a first node can be used to perform a credential lookup. A verified, issued credential is received when the credential lookup is successful. The framework allows for generating a zero knowledge proof using the verified, issued credential and for providing the zero knowledge proof. When the zero knowledge proof is received at a second node, the zero knowledge proof can be used to verify a criteria.

### SUMMARY OF THE INVENTION

Currently, financial organizations do not allow merchants or consumers to have control over access of their personal data during application processing/onboarding, transactional payment processing/settlements, and in data marketplaces. This lack of control avails consumers and merchants to repetitive application processes and potential identity theft. Moreover, legacy networks are very difficult to incorporate additional services and functionalities such as regulatory audits, servicing unconnected third parties (e.g., merchants and governments), supply chains, credit securitization, and sales tax settlements. As such, it is difficult to ensure data privacy, integrity, and security for all participating parties. This process is cumbersome and there are several opportunities to improve upon this process.

As mentioned above, third parties have to submit their personal data every time an application is submitted. For example, if a merchant is applying for a particular license, the merchant has to submit all of their personal information as required in the application. Thereafter, if the merchant wants to apply for another license or a completely different application, the merchant would have to resubmit all of their personal information, thereby creating a very repetitive and tedious process that is a waste of resources and time. Moreover, the more instances a consumer or merchant submits their personal data, the more likely it becomes that they will lose control of their personal data and avail themselves to identity theft and fraud.

### BRIEF DESCRIPTION OF THE DRAWINGS

To provide a more complete understanding of the present disclosure and features and advantages thereof, reference is made to the following description, taken in conjunction with the accompanying drawings, in which:

FIG. 1 illustrates an example of a blockchain system in accordance with an embodiment.

FIG. 2 illustrates an example of facts shared in a distributed ledger in accordance with an embodiment.

FIG. 3 illustrates an example of a flowchart of a fact lifecycle in accordance with an embodiment.

FIG. 4 illustrates an example of a flowchart of a transaction that is ready to be committed to a distributed ledger in accordance with an embodiment.

FIG. 5 illustrates an example of contract and state representations in accordance with an embodiment.

FIG. 6 illustrates an example of a flow chart of a transaction in accordance with an embodiment.

FIG. 7 illustrates an example of a high-level overview of a node in accordance with an embodiment.

FIG. 8 illustrates an example of a flow chart of utilizing a decentralized identifier in accordance with an embodiment.

FIG. 9 illustrates an example of a flow chart of utilizing a zero knowledge proof in accordance with an embodiment.

FIG. 10 illustrates an example of an identity ledger in accordance with an embodiment.

FIG. 11 illustrates an example of a flow chart of a process of verification in accordance with an embodiment.

FIGS. 12-14 illustrate an example of a process of transaction settlement in accordance with an embodiment.

FIG. 15 illustrates an example of a node in accordance with an embodiment.

FIG. 16 illustrates an example of a flow chart of merchant onboarding in accordance with an embodiment.

FIG. 17 illustrates an example of a flow chart of network permissions in accordance with an embodiment.

FIG. 18 illustrates an example of a flow chart for payment processing in accordance with an embodiment.

FIG. 19 illustrates an example of a flow chart of a data marketplace in accordance with an embodiment.

FIG. 20 illustrates an example of observer nodes in accordance with an embodiment.

FIG. 21 illustrates an example of a network environment through which different types of client devices participate in transfers via a distributed blockchain ledger.

FIG. 22 illustrates an example of a block diagram of a computing device that may be used to implement some aspects of the subject technology.

### DESCRIPTION

Embodiments of the present invention provide for a fully automated and distributed financial system including onboarding to a financial network utilizing a digital ledger, payment processing and settlement, and a data marketplace in which consumers and merchants can control over access to their data on the network.

Further embodiments include a network that can be easily adapted to simplify regulation and auditing services through observer nodes and take advantage of newly formed connections between parties that were otherwise unconnected. Examples include third parties, merchants, and governments that can support new functionalities such as a shared supply chain, improved credit securitization, and real-time sales tax settlement.

Examples of business components include merchant onboarding, customer onboarding, payments processing, and a distributed self-sovereign data marketplace. The systems and methods described herein can eliminate repetitive data entry by following an “enter-data-once” principle; substantially guarantee a deterministic merchant/customer approval process; ensure data privacy, integrity, and security for all parties; minimize error and increase financial and temporal efficiency at various stages of a payment process; and place consumers/merchant principals in control of their data.

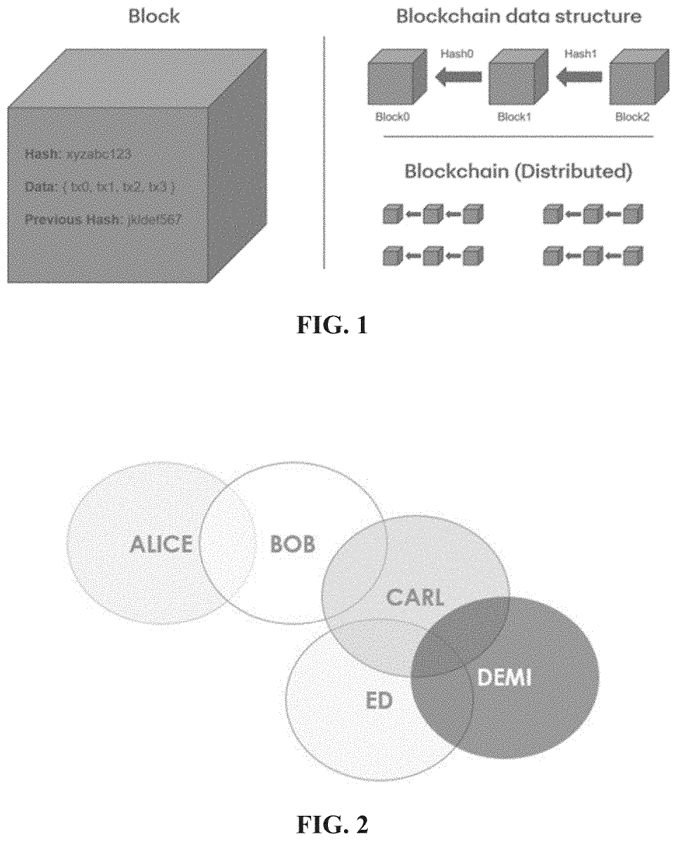

FIG. 1 illustrates an example of a blockchain system in accordance with an embodiment.

Hash Functions and Cryptography:

Hash functions and their outputs (e.g., hashes) can form the basis of a blockchain data structure and can be what enables blockchain to be exceptionally tamper-resistant. Cryptography, specifically asymmetric cryptography, can be the main underlying concept for understanding digital credentials.

A hash function can be a function that accepts a variable-length input and returns a fixed-length output (e.g., a hash). The hash function can based on input data such that the likelihood of generating the same hash from two different inputs (e.g., a collision) that is unlikely. As such, a hash can serve as a unique identifier or a “digital fingerprint” of the data that it represents.

Digital signatures can be understood in the context of asymmetric, or public-key, cryptography, which is a form of cryptography (e.g., a set of mathematical systems used to secure communications) in which the message sender can use a receiver's public key, which is available to all, to encode the message. The message can only be decoded by use of the receiver's private key, which should only be known by the receiver. Thereby, generating secured communications.

However, a second use case of asymmetric cryptography can be authentication, by the sender's use of their private key to sign the message. This process and its resulting addition/modification of the original message can be a digital signature. Using the sender's widely available public key, a receiver can verify that the originator of the message was indeed the sender.

Blockchain:

A blockchain can be a distributed digital ledger that is virtually immutable because of the way in which each “block” of data points back to the previous block. Moreover, multiple copies of the digital ledger can be easily checked against another digital ledger to verify information in the digital ledger.

A block can include three components: 1) Data. This can be any data including data describing a transaction. Transactional details can change in the overall state of the ledger. The state of a ledger can consist of various attributes that are modified over time by committed transactions; 2) The hash of the previous block. If a block is in question is the very first block in the chain, it is known as the genesis block. In this case, this field can be a default value such as zero; 3) The hash of the combination of the data and the hash of the previous block. The input to the hash function can consist of both the transactional data and the hash of the previous block.

Blockchain and Tamper-Proofing:

When chained together by hashes (e.g., each additional block points back to the previous block via the previous hash field), linked blocks can form a blockchain data structure. A benefit of this data structure over traditional linked lists is that linking by hashes offers tamper detection by default. For example, for a single instance of a blockchain residing on a single node, suppose a malicious actor attempts to modify the transaction data from a block. Then, the hash of the data will no longer match the data and tampering is detected at that block because the chain is now broken.

Once tampering is detected, the chain can be restored by reverting to a previous version, assuming some form of backup exists. Now, suppose the hacker also sets the hash of the block to the hash of the modified data. Then, the next block will no longer point back to the modified block, since its previous hash field no longer matches the hash of the corrupted block, thereby tampering is detected as in the first case. To make modifications to the blockchain without breaking the chain, a malicious actor must regenerate all the hashes for the targeted block and all of the blocks after it.

Depending on the size of the blockchain, it can generate all of the hashes for a modified block and all blocks after it since hash functions are not computationally intensive. That is, hashes are relatively easy to generate, but can be nearly impossible to reverse or create a collision.

Moreover, blockchain is distributed, which means that multiple parties can have a copy of the digital ledger and that these copies can be easily checked against each other by comparison of the most recent block hash. In effect, a third party would have to make the same modification on at least half of the ledger copies to have the change be reflected in the state of the collective digital ledger. As many parties can have a copy of the digital ledger and each party can have different mechanisms for securing access to their copy, it is highly unlikely that a malicious actor can change the collective ledger. As such, blockchains can be highly immutable as it is nearly impossible to retroactively change entries on the ledger in a large blockchain network.

As a blockchain is a distributed system, it can satisfy the property that nodes on a network be formed with an agreement on the state of the ledger. This implies that nodes can agree upon all transactions that occur as transactions are modifications to the collective state. A distributed system fails to function properly if its nodes do not ultimately agree upon the same state.

The challenges of a distributed system can be explained in the following analogy: The Byzantine Generals' Problem.

Consider a scenario in which a group of Byzantine generals surround a city with the intent of conquering it. The generals need a unified plan, either attack or retreat. A split decision will certainly result in the greatest loss. However, the generals are separated by a distance and must communicate their messages by foot. In addition, there are several traitorous generals that intend to sabotage the Byzantine effort. The generals rely on their communications to reach a consensus on whether to attack or fall back, but their messages can fail in a few ways. The message can fail to reach its destination or the message can be intercepted and then falsified by a disloyal general.

In an embodiment, the blockchain network are similar to the Byzantine generals, and the consensus that the blockchain nodes much reach is on whether to commit (e.g., approve/finalize) a transaction or not. Solutions to the set of problems described by the Byzantine Generals' Problem are called consensus algorithms.

Tokens:

Some algorithms can include using digital tokens to incentivize transactional processing (e.g., mining). Mining is a special type of transactional processing in which a node can be the first to solve a given difficult mathematical problem to commit a set of transactions and earn a set-amount token reward.

Permissions and Accessibility:

A blockchain can be permissionless (e.g., access to the ledger is unrestricted) or permissioned (e.g., a party must have their identity verified and known to be granted permission to join).

Consensus Algorithms:

A list of consensus algorithms are provided below:

Proof of Work (PoW):

Proof of Work can impose a requirement on hashes for a hash to be deemed valid. For example, a valid hash may have to start with five zeroes. A nonce value can be appended to the data to vary the generated hashes.

To obtain a valid hash, a party can iterate the nonce value and keep generating hashes until the condition is satisfied. The first node to complete solving the problem gets to validate the associated block of transactions and receive a small token reward for completing the process.

Because this mining is especially resource-intensive, it is very secure but is also energy inefficient. For example, it can take around 10 minutes or more for a block to be verified in a digital ledger.

Proof of Stake (PoS):

Proof-of-Stake can use a lottery-based selection of a node to vary a block of transactions. The larger one's stake in the network (e.g., the amount of Ether held), the greater the chance of being selected to verify a transaction. As such, large stakeholders have a greater interest in ensuring that the ledger remains accurate.

Since Proof of Stake does not involve solving computationally-heavy problems as Proof of Work does, it is more efficient. However, this type of algorithm can tend to be more centralized as larger stakeholders can effectively control the transactional process. Similarly, for Proof of Work, entities with more computational resources are more likely to win the race to verify a block.

Proof of Elapsed Time (PoET):

Proof of Elapsed Time can be a more efficient alternative to Proof of Work. Instead of generating many different hashes until a valid one is produced, nodes can wait for a random time. The first node to finish the timeout gets to validate the block and receive the associated reward. One caveat to this approach is that it requires extra checks to ensure that a node is not cheating the random wait.

Practical Byzantine Fault Tolerance (PBFT):

Practical Byzantine Fault Tolerance can employ a network-wide majority vote on whether to approve a block or not. It is tolerant of a third or fewer compromised nodes, can be adapted to work in either public or private ledgers, and is very resistant to malicious actors and crashes. The downside, though, is that it may require participation from many nodes, resulting in many messages being sent.

Proof of Existence (PoE):

Proof of Existence involves uploading a piece of validation data that proves that the transactions in the block are valid. It works in an assumed environment of partial trust and can be more suitable for internal business use or business-to-business use. Accountability serves as the negative incentive against cheating.

Smart Contracts:

A smart contract can be a portion of computer code that can be stored in a blockchain and executed automatically when processing transactions, also known as transaction processor functions. Smart contracts can be customized and paired with specific types of transactions. A smart contract can execute steps after certain conditions are satisfied. The smart contract also can include a set of rules by which the state of the ledger may evolve. The smart contract can be stored in the blockchain to ensure that every node executes the same code since data stored in a blockchain is virtually immutable.

Zero-Knowledge Proofs:

A Zero-Knowledge Proof (ZKP) can be a mathematical proof to verify a claim using cryptography that does not require knowledge of the exact data. For example, to enter into an alcoholic serving bar, an individual must be 21 years or older. Without revealing their birth month and day, a 30-year-old person may create a ZKP to prove that they are older than 21. The bar can verify the proof, which also can include a mathematical guarantee that the credential used is the same as what was used to prove the person is over 21.

FIG. 2 illustrates an example of facts shared in a distributed ledger in accordance with an embodiment.

R3 Corda is an example of a privately permissioned distributed ledger framework designed with privacy, finality, and scale. The framework can facilitate transactions through smart contracts and can be a component of embodiments in the Distributed Credit Ecosystem. The framework can run on a private blockchain. The information in the blockchain can be distributed to parties that are involved in a transaction, rather than the network as a whole. The network can enable applications and services to be run across a common network so that users can deploy once and have access to the entire network. The framework can also include a legal prose in smart contracts and not be subscribed to “code is law” and use existing legal systems as a fallback for any disputes.

The Ledger:

Embodiments of the framework can be a privately permissioned blockchain. As such, facts are not global. Below is an image of how facts are shared on the ledger. Unlike other frameworks facts are not broadcast globally, but all the network participants are fully connected and are able to communicate with each other.

Public identifiers can include one or more of the following: Common Name, Country, Locality, Organization, Organization Unit, State, and/or Principal.

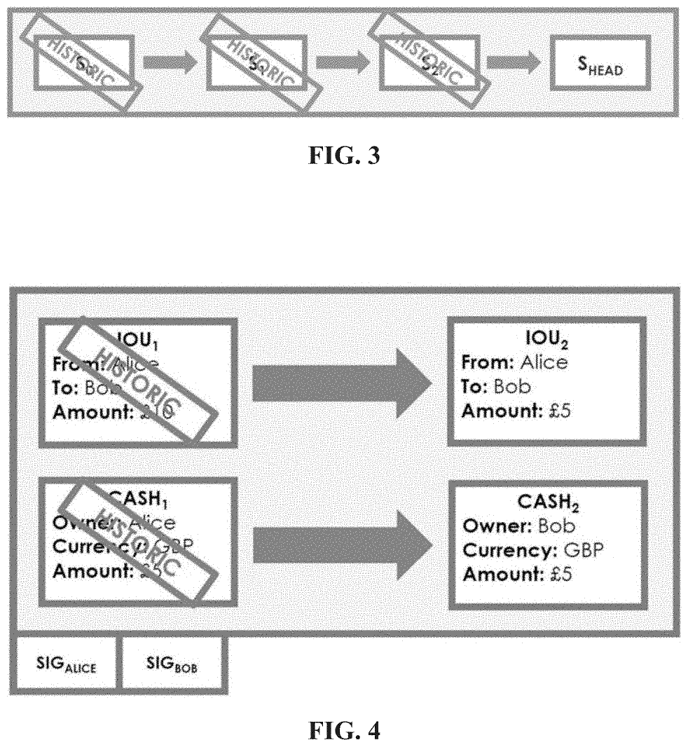

FIG. 3 illustrates an example of a flowchart of a fact lifecycle in accordance with an embodiment.

States can be immutable objects that represent shared facts such as an agreement or contract at a specific point in time. One example of such an agreement or contract is an “IOU.” The IOU can be an agreement of one party to pay another party with a set due date. The life cycle of the changes made to these states can be represented by a state sequence. When there is an agreement to change a state, the old state can be marked as historic and the sequence head (e.g., current state) can be moved to the new state. These historic states are not considered on-ledger, but the states can be accessible so that they can be audited in the future to verify transactions.

FIG. 4 illustrates an example of a flowchart of a transaction that is ready to be committed to a distributed ledger in accordance with an embodiment.

Transactions can be a method of providing atomic updates to a ledger. A transaction can be comprised of zero or more input states and zero or more output states. A transaction can be irreducible and indivisible, meaning that all the changes must happen, or none will occur at all. There can be three types of transactions: Updates, Exits, and Issuances. An Issuance can create a new state on the ledger and can be used to establish an agreement on the ledger. Updates can change state properties by taking one or more input states and generating one or more output states. An example is cash transfer, where the owner of the cash can be updated. Exits remove states from the ledger. To update the ledger, transactions can be digitally signed by all the parties involved in the transaction. These transactions also can be verified, which is done independently on each end of the transaction. In order to be immutable (i.e., not able to change), each transaction can be linked with the previous transaction's hash so that transactions in the past cannot be changed.

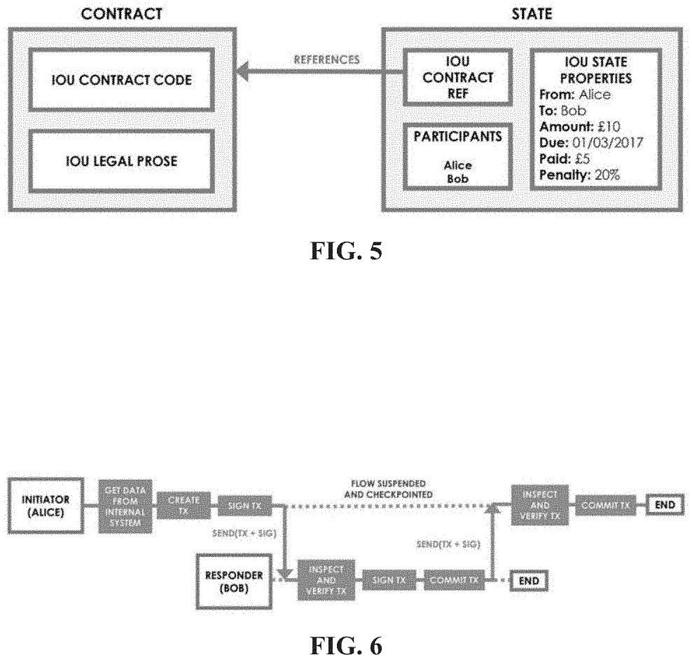

FIG. 5 illustrates an example of contract and state representations in accordance with an embodiment.

Smart contracts can assist facilitate transactions. Smart contracts can be broken up into two components, each with a specific purpose: 1) Contract Code: Used to verify the transaction; and 2) Legal Prose: A legal contract of the agreement so there can be a fallback if there is a dispute.

The contract code can be run in a sandbox (e.g., in a Java Virtual Machine (JVM)) that can be deterministic (i.e., the result can be the same every time). The result may not rely on any information that can change with time. This is important because the contract code is run independently on each party in order to ensure that the transaction is the same from each perspective. Without consensus from all of the parties, the transaction may not be verified. The legal prose can be present because disputes can happen at any time and the current legal system is a way of resolving these conflicts.

FIG. 6 illustrates an example of a flow chart of a transaction in accordance with an embodiment.

In another embodiment, flows can be a part of the system and method. Flows can be the basis of logic that occurs within the system. Flows can control When, What, and with Whom to communicate with. Back and forth communication is often required to commit a transaction to the ledger and flows can aim at solving that problem. In one embodiment, platforms can include gossip networks, which broadcast their data to everyone in the network. In yet another embodiment, a recipient can be specified. The advantage of this system is that users are in control of their data and information is shared only between those who need it. Flows can be either paired or one-sided and do not have to send data to other peers in the network. Flows can either be autonomous or require human input. For example, flows can take seconds or hours depending on how long it is waiting for a response. When a flow is handed off to a responder, flows can be checkpointed. This enables them to be serialized and stored on disk, allowing for more flows to be in progress than would normally fit in memory. Portions of flows can also be reused. Sub-flows can also be utilized in the system. Sub-flows can be reusable pieces of code that can accomplish a common task and that can be similar to a flow and can be called from a flow itself.

As shown in FIG. 6, an embodiment of a progress of a flow over time illustrated. First, an initiator (Alice) can receive data from an internal system, create a transaction, and sign the transaction. The transaction and signature can then be sent to a responder (Bob) who can then inspect and verify the transaction. The responder can then sign and commit the transaction and provide the same to be checkpointed for further inspection and verification of the transaction, which can then be committed.

Notaries:

Notaries can assist in providing a unique consensus. A notary can track used states in order to provide uniqueness consensus. Notaries can check if any input state in a transaction has been marked as historic. If any state has been marked as historic, then the transaction will fail to be signed by the notary service.

There are two types of notary services: verifying and non-verifying. The non-verifying notary only checks to see if the input states have been marked as historic and do not verify past transactions. The verifying notaries need to see the transaction contents. However, this exposes data to another party, which may be used when peers cannot be trusted.

Notaries can be run by any network peer, but they are often run as a cluster of nodes and can use consensus algorithms.

Oracles:

Contract code cannot rely on information that changes. Oracles can help solve this by being information brokers. The oracles can accomplish this by creating digitally signed data structures that assert certain facts. The data can be sourced in two ways: 1) On-Ledger States and Attachments, which calculate its results based on inputs received; and 2) Off-Ledger, which source data from external observations. Examples of oracles include how banks and financial services operate. The oracles have trusted entities that provide data. For example, oracles/oracle nodes can be the DMV, Social Security Administration, Universities, financial institutions, and any other trusted entity suitable for the intended purpose and understood by a person of ordinary skill in the art.

Embodiments of the system include custom code that can be run on a node in order to carry out business logic. The system can contain flows, contracts, and states that can be used through flows.

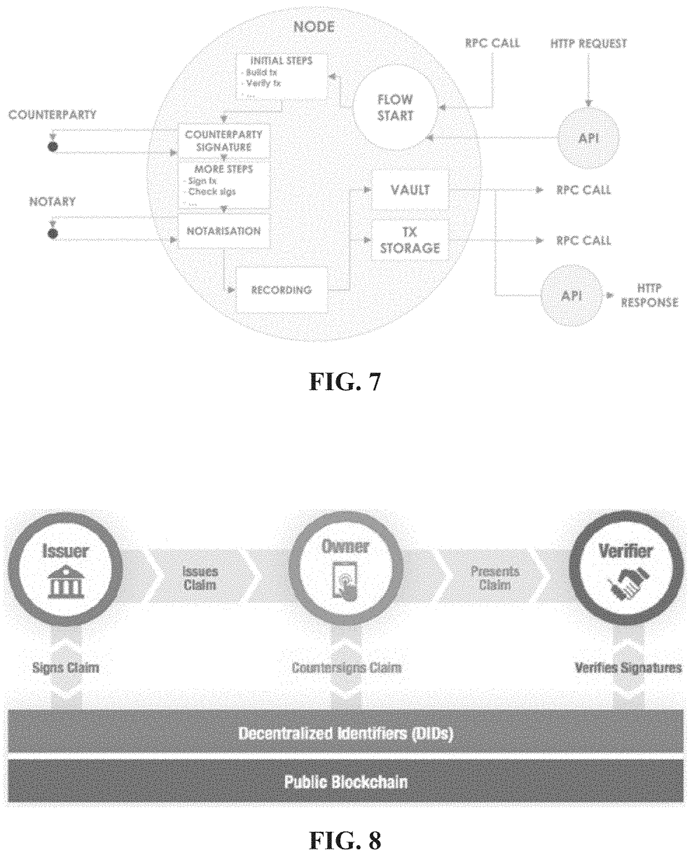

FIG. 7 illustrates an example of a high-level overview of a node in accordance with an embodiment.

Nodes can be the backbone of the network system. The nodes can be run in a JVM and provide a variety of services. These include:

1) Vault: stores output states relevant to a particular node (SQL DB);

2) Transaction Storage: key value store for attachments, transactions, and serialized state machines;

3) Flow State Machine Manager: manages operation of flow state machines;

4) Identity and Key Management: manages various supported identities and generated keys used to sign transactions;

5) Scheduler: schedules operations for future points in time;

6) Network Map: searchable “phone book” of nodes on the network;

7) Notary: obtains authorized signatures; and

8) Messaging: interface with other nodes for communication.

The nodes also can be accessed through RPC calls and HTTP requests.

FIG. 8 illustrates an example of a flow chart of utilizing a decentralized identifier in accordance with an embodiment.

In an embodiment, a blockchain framework can be designed for identity management. The framework can operate on the principle of self-sovereign identity, which means that users have control over their own identity across a global network, as opposed to having centralized identity silos. Additionally, the framework can leverage zero-knowledge proofs to enable users to only reveal as much as is necessary to fulfill the predicates of a proof request. An example of a blockchain framework can include Hyperledger Indy or any other blockchain framework suitable for the intended purpose and understood by a person of ordinary skill in the art.

DIDs/DID Documents:

Users can be identified by a decentralized identifier (DID), which can be linked to a document containing public keys. A DID can be public or private. A DID can be a unique verifiable identifier linked with a set of public keys and authentication mechanisms such that the owner of a DID can prove ownership of the public keys. The DID can be a W3C open standard. Public DIDs can be recorded on a public ledger for high availability and be reserved for public entities and issuers such as governments and credit bureaus. This allows both credential holders and verifiers to be sure that the issuers of credentials are who they say they are. Private DIDs are not recorded on the public ledger, but instead, can reside in “micro-ledgers” between two or more parties for whom the DID is relevant, as in the case of a business relationship.

A user can use the same DID across relationships or use pairwise-unique DIDs (e.g., one per relationship) to remain pseudonymous and reduce the chance of a correlation attack, which can occur when a malicious actor successfully compiles information on a target across several data sources into a set of sensitive data.

A DID can also be linked to a DID Document, which lists associated public keys and links to authentication services. Public keys can be used for authentication and the extra authentication services can be used to prove ownership of the public keys. A DID Document can link to zero or many external authentication services. In the case of a user who has lost access to their own DID, a third-party backup service can be utilized to regain access.

Public Vs. Private Ledger:

An embodiment of the system can include a node pool that can host a public ledger that can contain a record of public DIDs, as well as verifiable credentials schema and credential definitions, which can include revocation registries.

PII Stored Off-Ledger:

Personal identifiable information should not be stored on a public ledger. Instead, transmission of verifiable claims can occur point-to-point.

Digital Credentials/Wallet, Issuers, Holders:

Digital credentials can be a set of digitally signed attributes that belong to a user or a credential holder. The digital credentials can be provided by an Issuer, and upon receipt, can be securely stored in a digital wallet.

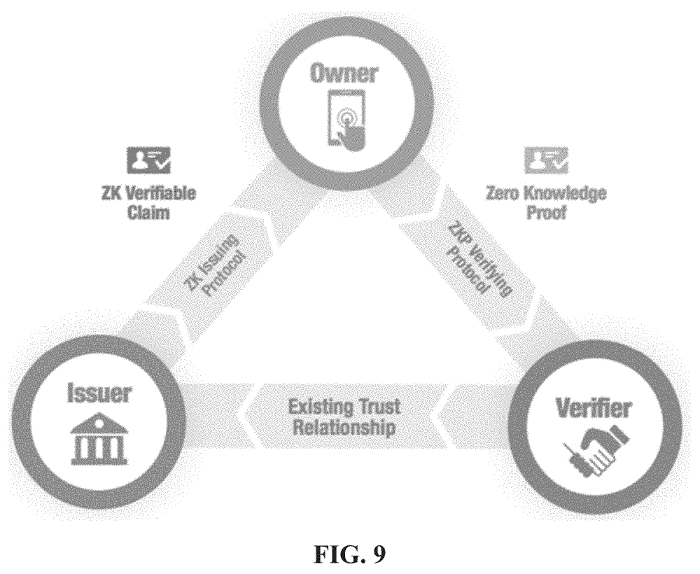

FIG. 9 illustrates an example of a flow chart of utilizing a zero knowledge proof in accordance with an embodiment.

Network Entities:

Public Ledger Nodes

The public ledger can be maintained by two different types of nodes: validators and observers. A validator node can be responsible for committing new DIDs, DID Documents, schemas, and credential definitions to the public ledger. Observer nodes can hold a copy of the public ledger for availability and tamper-resistance.

Agents

An agent can be a node or service that acts on behalf of a user. Human users do not physically communicate with the network themselves, but instead issue commands that the agent can then execute in code.

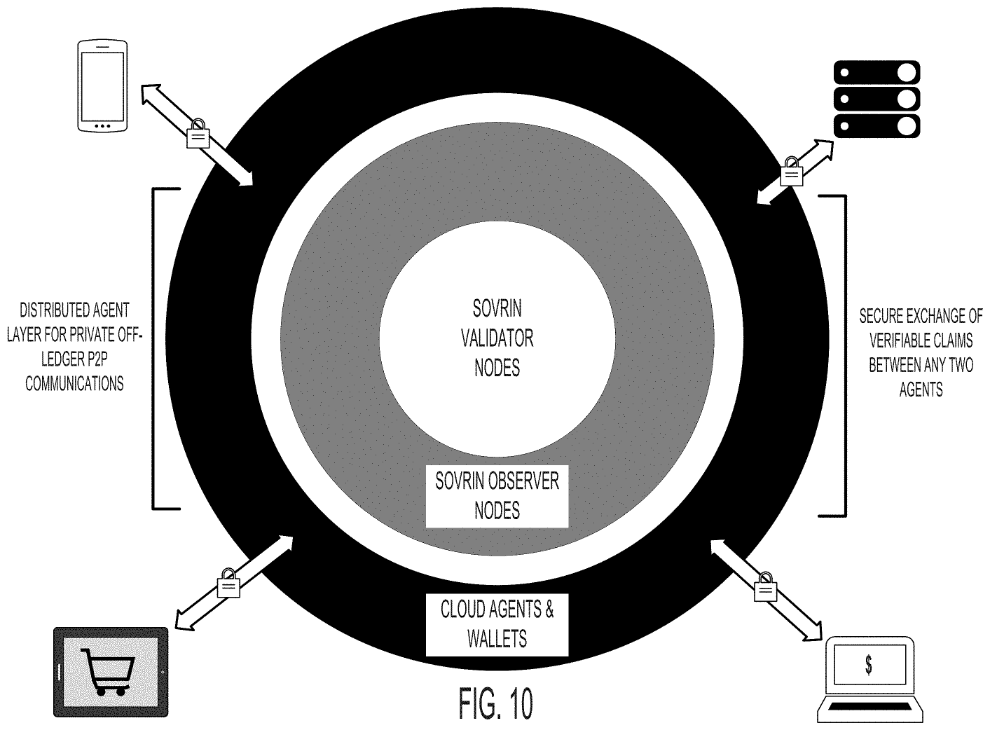

FIG. 10 illustrates an example of an identity ledger in accordance with an embodiment that utilizes distributed agents, observer nodes, and validator nodes.

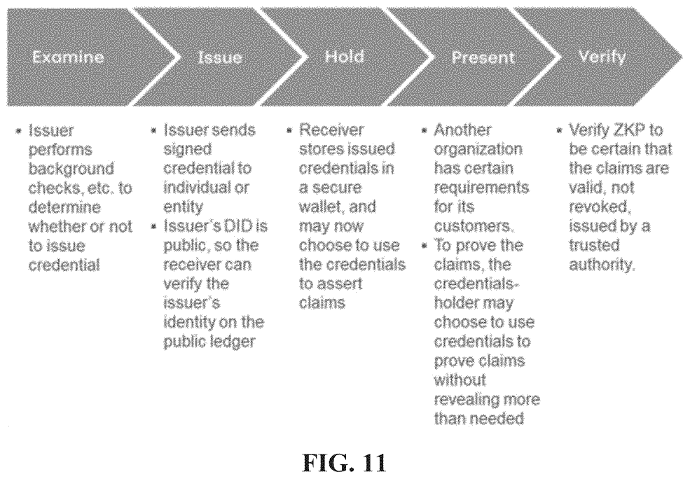

FIG. 11 illustrates an example of a flow chart of a process of verification in accordance with an embodiment.

In an embodiment of an onboarding process, a business entity can provide a service that defines a set of conditions that must be true of the counter-party to establish a relationship with them. Verifiable claims can be claims that are asserted by a prover (e.g., a credential holder) to satisfy a proof request from a verifier. The proof request specifies attributes required to be revealed, as well as a set of predicates that must be satisfied to complete the proof.

Using the digital credentials held in their wallet, a user's agent can generate a cryptographic proof that asserts ownership and validity of the credentials used, as well as satisfaction of the proof predicates through a ZKP. By doing so, a verifier can be confident that the credential holder satisfies its requirements, and the applicant does not have to reveal the attribute that is the subject of the requirement.

Revocation Registry:

In the public ledger, a revocation registry can be present for each credential definition. The revocation registry can be a number that is incremented per credential revoked such that, given a credential, it may be deduced whether the credential has been revoked by the issuer.

As shown in FIG. 11, an issuer can perform background checks to determine whether to issue a credential. The Issuer can then send a signed credential to an individual or entity. The Issuer's DID can be public so that the Receiver can verify the Issuer's identity on the public ledger. The Receiver can store the issued credentials in a secured wallet and can use the same to assert claims at a future time. If an organization has certain requirements for its customers, the credential holder can choose to use their issued credentials to prove claims without revealing more information than is necessary, thereby controlling their data. A ZKP can be verified to ensure that the claims are valid, not revoked, and issued by a trusted authority.

An example of an embodiment of the system can include some of the following flows:

1) AssignPermissionsFlow

From an Authority, a Trustee, and/or future Verifier, assign issuing permissions to the counterparty upon receipt of a permissions request message from an Issuer.

2) CreateCredentialDefinitionFlow

An Authority can create a Credential Definition on the shared ledger based on a given Schema. This can include an instance of a revocation registry.

3) CreatePairwiseFlow

A pairwise channel can be generated between an Issuer and a potential Credential Holder. This flow can include mechanisms to verify the identity of the counterparty by exchanging DIDs. This can be initiated by a message from the Prover (e.g., the Credential Holder).

4) CreateSchemaFlow

An Authority can create a data schema for a digital credential in the digital ledger.

5) GetDidFlow

Can allow one node to obtain the DID of its counterparty.

6) IssueCredentialFlow

Can allow an Issuer to issue a credential to a Prover/Credential Holder that can be initiated by the Issuer, who sends a Credential offer to the Prover.

7) RevokeCredentialFlow

Can revoke a credential by updating the revocation registry.

8) VerifyCredentialFlow

As the Verifier, this flow can verify the set of cryptographic proofs created by the Prover by using various credentials to satisfy the conditions of a Proof Request. The flow can be initiated by the Verifier via a proof request sent to the Prover.

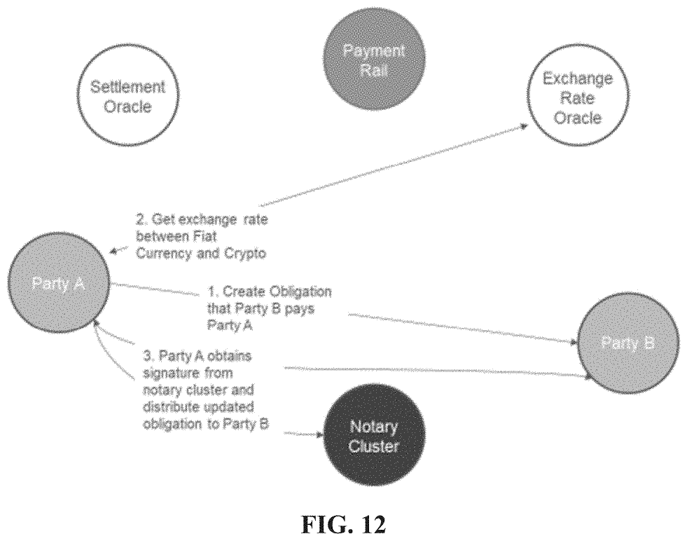

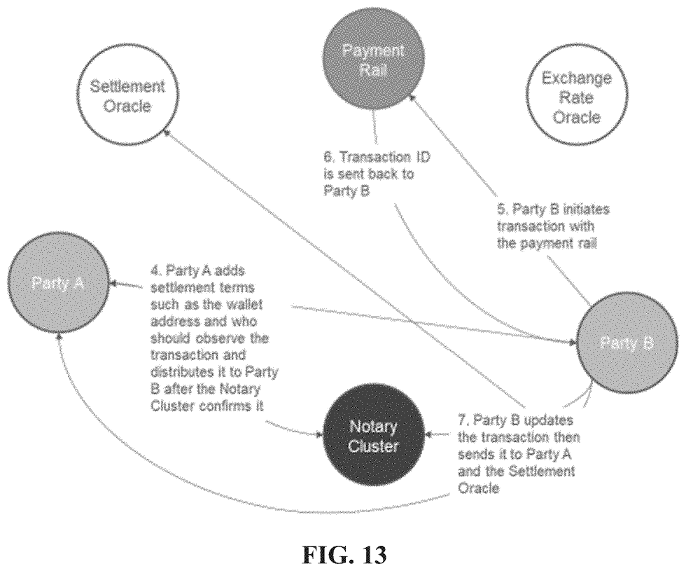

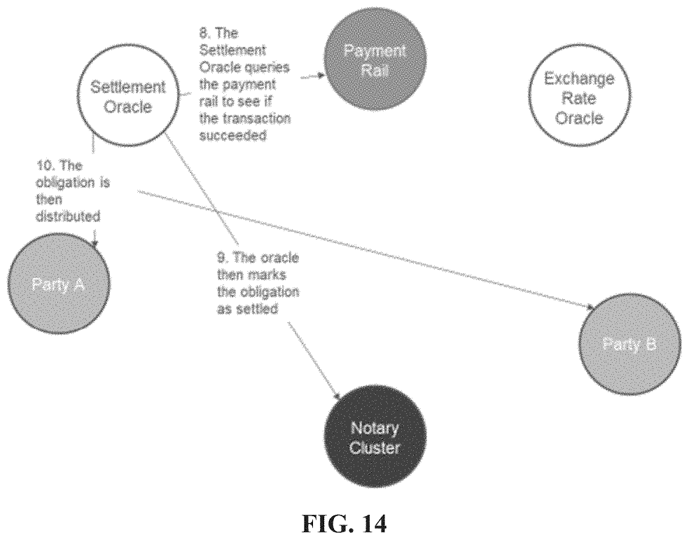

FIGS. 12-14 illustrate an example of a process of transaction settlement in accordance with an embodiment.

In embodiment of the system can assist in settling transactions. The system can act as a bridge that connects users and merchants to external payment rails. The system can also connect to traditional payment rails (e.g., VisaNet or BankNet) or new rails such as RippleNet that utilize a blockchain. The following are flows that can be utilized to run a transaction.

Network Components:

1) Notary Cluster

2) Party A

3) Party B

4) Settlement Oracle

5) Exchange Rate Oracle

6) Payment Network

CreateObligationFlow:

A CreateObligation Flow can include the following parameters: Quantity (e.g., currency), a Token (e.g., Currency Code and Type), a role (e.g., Obligor vs Obligee), a counterparty name, a due date, and whether the transaction is anonymous.

NovateObligationFlow:

A NovateObligation flow can be called that facilitates obtaining exchange rates between different currencies. For example, when changing between Fiat Currencies like USD to cryptocurrencies like XRP, Party B can request the USD/XRP exchange rate from an Oracle and update the transaction. The transaction can then be signed by a notary cluster and distributed to the other party.

Update SettlementMethodFlow:

An UpdateSettlementMethod flow can be called which updates the settlement terms. The settlement terms can include the account to pay and whether to use a settlement oracle. This can then be signed by the notary cluster and distributed again.

OfffiedgerSettleObligationFlow:

An OffLedgerSettleObligation flow can provide the payment between the two parties. This flow can include the quantity of currency and the type of current used in the transaction. The Obligee can then send a transaction to the payment rail and update the obligation with the transaction ID. The settlement oracle can then query the payment network with the transaction ID and mark the obligation as settled by obtaining a notary signature and distributing the obligation to the two parties.

Merchant Onboarding:

The embodiments described herein can be implemented in a modular manner with interchangeable nodes that can be overlaid on top of existing or new networks.

Previously, the existence of every node (e.g., vendor, company, merchants, etc.) had to be known in order to begin the process of onboarding merchants. For example, measures had to be taken to confirm and verify each and every merchant for the onboarding process. This consumes many resources, is inefficient, time consuming, and expensive. This type of process also consumed more resources to determine the location of each merchant (e.g., node) prior to initiation of the onboarding process.

These past systems required separation of credential issuance from verification. Credentials were first offered by the issuer, rather than requested by the end user (e.g., a merchant principal). For example, in the scenario of a driver's license, a user has to provide all of the necessary documents and proofs to a DMV (e.g., oracle node) in order to receive a driver's license because the DMV is a trusted issuer of the driver's license. The user would then use the driver's license to verify their identity to third parties (e.g., at a bar, at a security checkpoint at the airport, etc.). This two-step process is inefficient and time consuming. In the system, as described below, after the DMV issues the driver's license (i.e., credential) to the user, the DMV also can provide verification directly to third parties of the identity of the user, thereby condensing the two-step process into a one-step process. This direct interaction by the oracle node to third parties and consumers can facilitate more efficient transactions while maintaining discretion in the distribution of personal information. In this case, the user would not be providing personal information to the third party directly, the third party would be contacting the oracle to receive authorized information of the user.

In another embodiment, verification can both be and not be obtained by direct interaction with a credential issuer. Verification can be provided by a digital signature included with a credential and by checking the credential against a revocation registry. Predicates can be set by the system and include verification of the credential issuer's identity by decrypting the digital signature (previously encrypted with a private key of the credential issuer) with the public key of the credential issuer. The predicates can also include an assertion that the credential has not been revoked, expired, etc. While the public key and the revocation registry are passively made available on the blockchain network (e.g., on the Hyperledger Indy network) by the credential issuer, embodiments of the system as described herein may not need to directly contact the credential issuer to obtain an active verification response.

Furthermore, the digital credentials can be obtained virtually and concurrently by an end user, but through a separate virtual, concurrent communication with the credential issuer. However, the end user (e.g., merchants) may not have to provide their information (e.g., personal information) over and over again, only once. In the embodiment where the end user is a consumer, the end user's digital credentials can be reused (or consolidated and reused) at each merchant, such that the consumer also may provide their personal information only once, thereby minimizing the opportunities of identity theft.

Each credential was then obtained one-at-a-time by the end user, from different endpoints, thus, requiring the user to submit the same information multiple times between the authentication/data lookup requirements at different issuers. Such processes are highly inefficient and a waste of costly resources.

In the present embodiment, a network that can utilize a digital ledger at multiple nodes can perform automated merchant node management including automatic instantiation, deletion, and upgrading of merchant nodes. Furthermore, the network can incorporate credential issuance and verification in a single automated process such that verification occurs immediately after issuance, rather than as disjoint processes that must each be initiated by the user.

Credentials can first be requested by the user and the credential request can include only the data necessary for credential lookup at the issuer without providing all of the user's data or personal information, thereby adding another layer of protection for the user (e.g., fraud prevention). For example, to enter into an alcoholic serving bar, an individual must be 21 years or older. Without revealing their birth month and day, a 30-year-old person may create a ZKP to prove that they are older than 21. The bar can verify the proof, which also can include a mathematical guarantee that the credential used is the same as what was used to prove the person is over 21.

Moreover, upon submission of an application, the application data can be automatically partitioned non-exclusively and sent to other issuers as part of a credential request so that the user only enters information once, thereby providing a non-repetitive process.

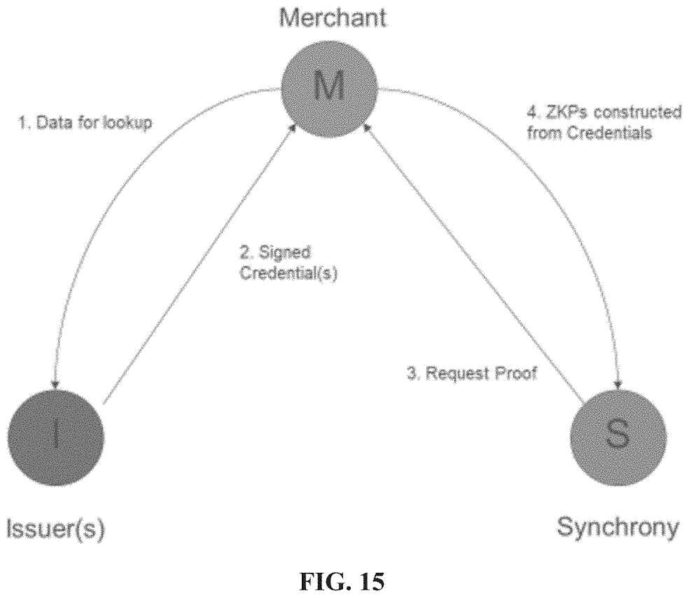

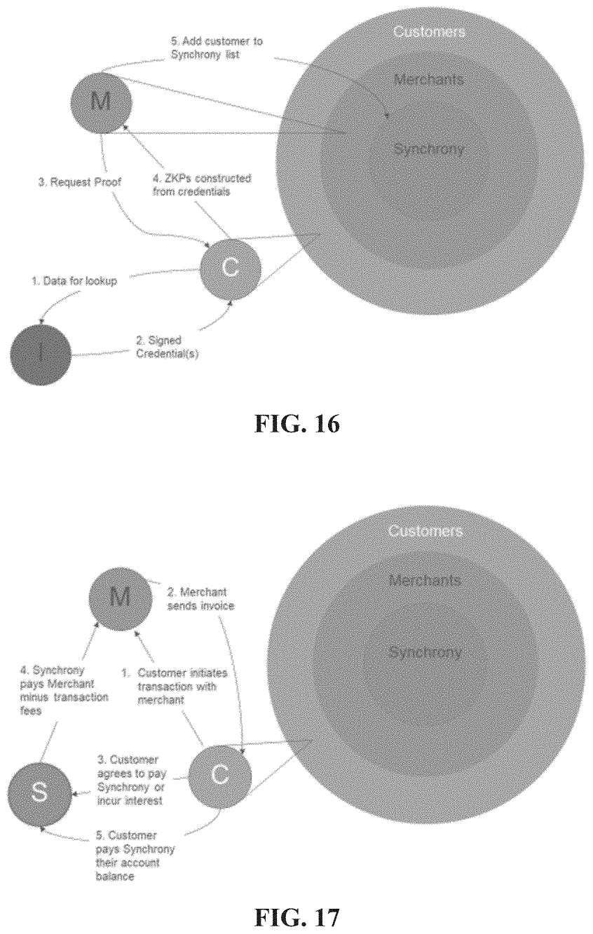

FIG. 15 illustrates an example of a node in accordance with an embodiment. FIG. 16 illustrates an example of a flow chart of merchant onboarding in accordance with an embodiment.

An embodiment of the present disclosure can include components configured to automate merchant onboarding/underwriting process, while respecting the privacy of merchant principals. Instead of storing and verifying consumer applications manually, which is very resource intensive, the merchant can send only enough information to trusted issuing entities (e.g., credit bureaus and city governments) to look up and issue a credential (i.e. credit score or home improvement license) without having to provide all of the merchant's personal information. Other examples of credentials applied for by consumers or merchants can include a driver's license, passport, education credentials, security authorizations, criminal background checks, home loan pre-approvals, physician credentials, and insurance background checks. The merchant can then use the newly issued credentials to create a ZKP, which can then be sent to third party.

Examples of Network Entities include:

1) Issuers: Credit Bureaus, City Governments (in the case of a Home Improvement Program applicant).

2) Credential Holders: Merchant principals.

3) Verifiers: Synchrony.

Network:

These components can be a part of a base network including a pool and nodes. Examples of nodes include Synchrony, major US credit bureaus, any participating city governments, credit agencies, banks, financial institutions, and third party companies with financial interests. Each node can have a reasonable level of access to internals of the organization it represents. In the absence of an Issuer node, a designated node can assume the role of Issuer and draw from existing data sources to issue credentials.

Dynamic Node Instantiation, Maintenance, and Deletion:

Upon receipt of a merchant application or creation of an account to apply as a merchant, a node can be dynamically instantiated on AWS on behalf of the merchant.

Merchant nodes that fail the application process can be automatically removed and deleted upon verification failure or upon session exit thereafter. Merchant nodes that pass the verification can remain and undergo further setup to enable customer application processing and payment settling features. These features can be added in the form subsequent components and processes distributed throughout the network (e.g., at multiple nodes). Nodes in the network can connect to an existing node pool.

Triggers are also provided in the system that automatically stop the process such as customer/merchant action initiation, an event occurring (e.g., stopped by the Issuer), a federal or state law that is passed prohibiting such actions, and time limits of when the process can end.

Network Permissions Setup:

The base network can be instantiated with a Trustee/Authority, which is an entity that has the authority to grant issuing permission to other entities. All prospective Issuers can be granted permissions by a verifying entity such as a financial institute. This can be performed by the AssignPermissionsFlow described above between the financial institute and each Issuer.

Credential Schema Examples:

1) BizID Score Schema: a) BizID Score; and b) Datetime Issued.

2) Credit Score Schema: a) Credit Score; and b) Datetime Issued.

3) Home Improvement License Schema: a) License Number; b) Issuing City; and c) Date Issued.

Embodiments of the flows implemented in the system include:

1) BizIdScoreIssueFlow

A merchant principal or merchant representative can provide data required for a BizID lookup to an Issuer without having to provide all personal or relevant data. The responding node can then invoke IssueCredentialFlow with a BizID Score as a Credential, if available. The flow can time out or fail by exception if the lookup fails. Lookup fails can include not having good or enough credit, on a prohibited list, and information in the data do not match or correspond to one another. Upon receipt and acceptance of the BizID Score, the merchant can then initiate a BizIdScoreVerifyFlow with a financial institute.

2) BizIdScoreVerifyFlow

The merchant principal can send node information to the financial institute such as Synchrony. In response, the financial institute can then invoke VerifyCredentialFlow with the BizID Score and timestamp the lower bound thresholds as a predicate in a proof request. If the flow times out and/or fails to find a suitable Credential, the flow fails.

3) CreditScoreIssueFlow

The merchant principal or merchant representative can send data required for a credit score lookup to the Issuers (e.g., credit bureaus) without having to provide all of their personal data. The responding credit bureau nodes can then invoke IssueCredentialFlow with a Credit Score as the Credential, if available. The flow can time out or fail by exception if the lookup fails. Upon receipt and acceptance of the Credit Scores, the merchant can then initiate CreditScoreVerifyFlow with the financial institute using the node of the credit bureau that issued the lowest credit score.

4) CreditScoreVerifyFlow

The merchant principal can send the node of the credit bureau that issued the lowest credit score to the financial institute. In response, the financial institute can then invoke VerifyCredentialFlow with the Credit Score and timestamp the lower bound thresholds as a predicate in the proof request. If the flow times out and/or fails to find a suitable Credential, the flow fails.

5) HILicenseIssueFlow

The merchant principal or merchant representative can send data required for a Home Improvement license lookup to the Issuer (e.g., city government, specified in a submitted application). The responding city government node can then invoke IssueCredentialFlow with Home Improvement License as the Credential, if available. The flow can time out or fail by exception if the lookup fails. Upon receipt and acceptance of the Home Improvement License, the merchant can then initiate the HILicenseVerifyFlow with the financial institute.

6) HILicenseVerifyFlow

The merchant principal can send the city government's node information to the financial institute. In response, the financial institute can then invoke VerifyCredentialFlow with the Home Improvement License Number as an attribute in the proof request. If the flow times out and/or fails to find a suitable Credential, the flow fails.

Process Flow:

The following can be performed by any of the nodes within the network, which can be automated on behalf of an entity:

1) Data receipt/partitioning: The merchant application can be received from a source, either a merchant application portal or elsewhere. The data can then be partitioned into four categories:

a) Data for a BizID score lookup;

b) Data for a credit score lookup;

c) Data for a home improvement license lookup, in the case of a Home Improvement Program application; and

d) Data that can be sent directly to the financial institute, only as much as is necessary to maintain a business relationship and satisfy compliance rules.

2) BizIdScoreIssueFlow→BizIdScoreVerifyFlow

3) CreditScoreIssueFlow→CreditScoreVerifyFlow

4) HILicenseIssueFlow→HILicenseVerifyFlow

Additional checks on the application data can be performed at various times of the process. In the case where a determine success/failure occurs, the return data can be provided to the financial institute. If, at any point a step fails, the entire process can fail and no or minimum data can be sent to the financial institute. If the steps pass, then the data from the fourth partition can be sent to the financial institute and the merchant is successfully onboarded. An onboarded merchant can utilize their credentials to apply for different applications or licenses without having to provide their personal information again, thereby limiting their exposure to dishonest actors that may want to steal their identity.

Other examples of credentials applied for by consumers or merchants include a driver's license, passport, education credentials, security authorizations, criminal background checks, home loan pre-approvals, physician credentials, and insurance background checks.

Customer Onboarding:

FIG. 17 illustrates an example of a flow chart of network permissions in accordance with an embodiment.

Customer onboarding is similar to the process of onboarding merchants as described above. In an embodiment, instead of being onboarded directly to the financial institute, customers can be onboarded through merchants using financial institute-specified requirements. In addition, customer onboarding can take advantage of merchant nodes as application processors to increase throughput and minimize excess messages. Customers also have the ability to stop the process of onboarding at any given time to limit exposing themselves to the system.

This embodiment can follow a similar process to the merchant onboarding process, except that the validating entities can be the merchants, not the financial institute. This can allow for distribution of the computational burden, rather than place the responsibility of customer application processing on one node.

Additionally, the process flow can re-use credentials to apply at other merchants. Data used for customer identification can also be shared between merchants with express permission from the customer. As in the merchant onboarding embodiment, this embodiment utilizes nodes and a distributed digital ledger for communication.

Examples of Network Entities include: 1) Issuers—Credit Bureaus; 2) Credential Holders—Customers; and 3) Verifiers—Merchants.

Dynamic Node Instantiation:

Upon receipt of a customer application or the creation of an account to apply as a customer, a node can be preinstalled and be dynamically instantiated on AWS on behalf of the customer.

Customer nodes that fail the application process can be automatically removed and deleted upon verification failure, or upon session exit thereafter, if the customers are not a part of the ecosystem through another merchant. If the customers have a relationship with other merchants, the node can remain.

Customer nodes that pass the verification can remain and undergo further setup to enable payment settling features.

Network Permissions Setup:

In an embodiment, a network relating to customer onboarding can be joined in conjunction with the network described above relating to merchant onboarding.

All prospective Issuers can be granted permissions by a verifying entity, and in this embodiment, these entities can be merchants. This can be done through the AssignPermissionsFlow described above between merchants and each Issuer.

Credential Schema Examples including Credit Score and Datetime Issued.

Examples of Flows in the network include:

1) CustomerCreditScoreIssueFlow

The customer can send data required for a credit score lookup to the Issuers (e.g., credit bureaus). The responding credit bureau nodes can then invoke IssueCredentialFlow with a Credit Score as the Credential, if available. The flow can time out or fail by exception if the lookup fails. Upon receipt and acceptance of the Credit Scores, the customer can then initiate the CustomerCreditScoreVerifyFlow with the Merchant using the node of the credit bureau that issued the lowest credit score.

2) CustomerCreditScoreVerifyFlow

The customer can send the node information of the credit bureau that issued the lowest credit score to the Merchant. In response, the Merchant can then invoke VerifyCredentialFlow with the Credit Score and timestamp the lower bound thresholds as a predicate in the proof request. If the flow times out and/or fails to find a suitable Credential, the flow fails.

Process Flow:

1) Data receipt/partitioning: The customer application can be received from a source, either a customer application portal or elsewhere. The data can then be partitioned into two categories:

a) Data for a credit score lookup; and

b) Data that can be sent directly to the financial institute, as much as is necessary to maintain a business relationship and satisfy compliance rules.

2) CustomerCreditScoreIssueFlow→CustomerCreditScoreVerifyFlow

Additional checks of the application data can be performed.

3) Determine success/failure, return data to the financial institute, if applicable. If a point/step fails, the entire process can fail and a minimum to no data can be sent to the financial institute. If all steps pass, the data from the second partition can be sent to the financial institute and the customer can be successfully onboarded.

As shown in FIG. 17, an embodiment of the network can include the following processes:

1) The Customer can provide data for a particular lookup to an Issuer;

2) The Issuer can provide signed credentials to the Customer;

3) The Merchant can provide a request for a proof from the Customer;

4) The Customer can provide a ZKP compiled from the credentials to the Merchant; and

5) The Merchant can add the Customer to an approved list of the financial institute.

Other examples of credentials applied for by consumers, merchants, or financial institutes include a driver's license, passport, education credentials, security authorizations, criminal background checks, home loan pre-approvals, physician credentials, and insurance background checks.

Payments Processing:

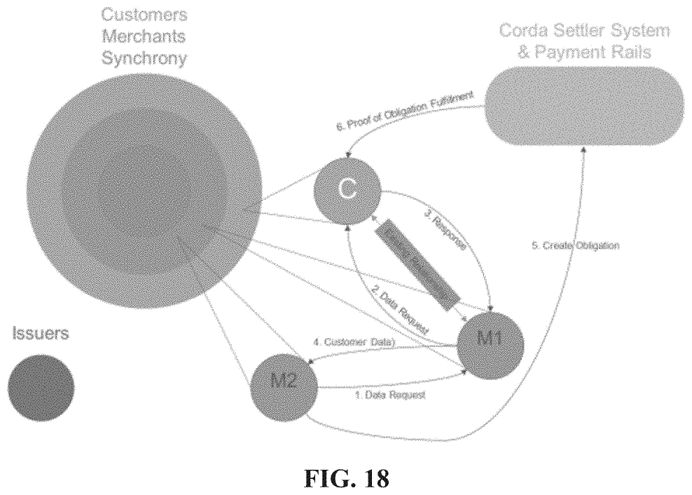

FIG. 18 illustrates an example of a flow chart for payment processing in accordance with an embodiment.

In an embodiment, the network can enable customers, merchants, and financial institutes to be able to complete payments with various payment rails while recording the validity of these transactions on a distributed ledger.

Examples of Network Entities include: Merchants, Customers, Settlement Oracles, Exchange Rate Oracles, and Notary Clusters. Nodes can be instantiated for the Settlement Oracle and the Exchange Rate Oracle.

Process Flow:

As shown in FIG. 18, an embodiment of the network process can include:

1) The customer can initiate a purchase with a merchant and request an invoice to make a payment to a financial institute, who can later pay the merchant;

2) The merchant can then send an invoice to the customer in the form of a digitally signed document;

3) After receiving the invoice from the merchant, the customer can then make a promise to the financial institute to pay the money for the purchase that the financial institute made with the merchant or customer will incur interest during the next billing cycle;

4) The financial institute can then pay the merchant in real-time minus transaction fees that the financial institute may impose; and

5) The customer can pay their remaining balance or minimum payment on their account with the financial institute.

Other examples of credentials applied for by consumers, merchants, or financial institutes include a driver's license, passport, education credentials, security authorizations, criminal background checks, home loan pre-approvals, physician credentials, and insurance background checks.

The financial institute can be an observer node in the transaction with the merchant so that the financial institute can ensure the correct amount is paid.

Data Marketplace:

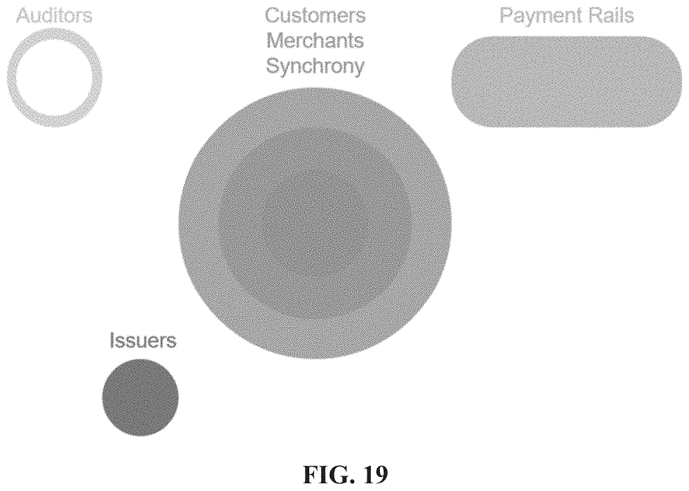

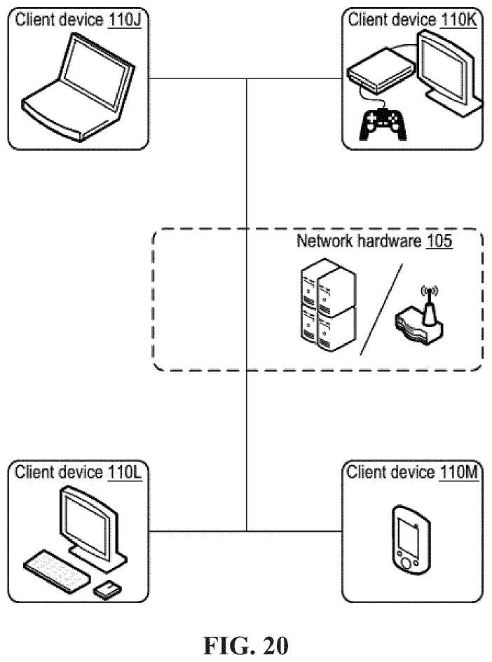

FIG. 19 illustrates an example of a flow chart of a data marketplace in accordance with an embodiment. FIG. 20 illustrates an example of observer nodes in accordance with an embodiment.

Previously, merchants or advertisers would contact consumers directly to solicit for their personal information or data in order to collect information regarding their shopping habits, political views, and financial endeavors. In such instances, customers or consumers may not even be compensated for providing their personal information due to logistics such as finding and contacting the consumer.

In an embodiment, a network can allow customers to authorize the distribution of their personal data (i.e., transactional data at a particular merchant) from the originating merchant to other merchants, rather than simply paying users to fill out surveys or watch advertisements. Reasons for such distribution can include improving product marketing towards the authorizing customer. The customer can then be compensated (e.g., monetarily or points) for such data. Merchants can be charged some rate by a data broker (e.g., Corda Settler System, a financial institute, DMV, oracle) to gain access to this feature, which creates an incentive for all parties to participate. In an embodiment, the data broker can facilitate the transaction between merchants and customers. The data broker would be storing the data of the customers, but facilitating the transaction particulars such as price and volume. Nodes also can be malleable. For example, a financial institute can be an oracle node (i.e., provider of data) and a data broker node. The financial institute also can shift from an oracle node to a data broker node. The system as described herein includes nodes that are malleable and configurable.

There could also be multi-tiered levels that have different price points depending of the level. For example, a higher tiered level can include a user's most important/personal information that can be priced at a higher value (e.g., $5/kilobyte of data), while a lower tiered level can include basic information that can be priced at a lower value (e.g., $1/kilobyte of data). The customer can also dictate the value of their personal data. For example, data of a celebrity or a renowned person can be worth more than a regular person's data. As such, the value and price point of a celebrity's data will be higher than a regular person's data. The data can be tagged with a “tier category” that indicates the price tier level (e.g., self-tagging). Packets of data can also be a part of the transaction to provide the customer with the opportunity to bulk sell their data. For example, a particular row or column of a sheet in the digital ledger can be designated for sale to a merchant by the consumer, thereby providing consumers with more control over their data.

In this embodiment, the system is similar to the systems described above for merchant/customer onboarding and payment processing. Furthermore, private DIDs can be implemented to authenticate customers and public DIDs can be used to verify merchant identities. The transaction can be stored that specifies the customer's data release permission grant in the shared ledger and create and settle the compensation obligation to the customer.

Examples of Network Entities can be similar to the network entities as described above.

Process Flow:

As shown in FIG. 19, an embodiment of the network process can include:

1) Merchant 2 can send a data request to all customers of another merchant, Merchant 1, through Merchant 1. The data request from Merchant 2 can request for information already held by Merchant 1 or data that only the customer knows. The data request can also specify data use case and privacy policies, compensation methods, amounts, conditions, and the originating merchant name.

2) Upon receipt of a data request from a merchant, a customer can choose to accept or deny the request. If the customer denies the request, the process can end.

3) If the customer accepts the request, an obligation of the merchant to the customer can be created and settled as described above.

4) The requested data can be securely transmitted to the requesting Merchant using encryption (e.g., asymmetric or symmetric) and DID Documents to find and verify public keys. The DID Documents can be looked up by each counterparty via GetDidFlow.

5) At any time, the customer can send a data deletion request to a merchant regarding their own data, thereby securing control of the customer's data by the customer. The request can be satisfied in accordance with applicable consumer data regulations.

Observer/Audit Nodes:

The embodiment can also include observer nodes such as auditor nodes to facilitate reviews and audits in an efficient manner. Observer/audit nodes can provide access to certain information required for respective audits. For example, embodiments can include an access point (e.g., observer/audit node) that includes required/requested information of an audit to then be received/accessed by auditors such as government agencies. Previously, government agencies would audit a merchant and request specific information regarding their customers and transactions. The merchants would then have to hire professionals or have their employees spend numerous hours compiling all of the data requested in the audit. The previous method is very labor intensive and costly. In this embodiment, the access point can be continuously updated (by a merchant, issuer, oracle node, etc.) with the requested information from an audit so that an auditor can access the requested information from the access point (i.e., observer/audit node) at any given time, thereby tremendously reducing the cost of complying with an audit request.

The blockchain system also can be another factor that allows the government agencies to securely connect to the access point (i.e., observer node) and obtain the necessary information for the corresponding audit. For example, the observer node can be a decentralized node within the blockchain system that provides access to a digital ledger that includes the corresponding information for the audit. As auditors may not have access to internal centralized databases of the companies that they are auditing, the system as described herein can provide auditors with the opportunity to access audit designated files at any given time without having to force companies to spend large amounts of money in preparing individualized audit reports. Moreover, the decentralized observer/audit node provides another measure of security as the blockchain system has no centralized database for a hacker to exploit.

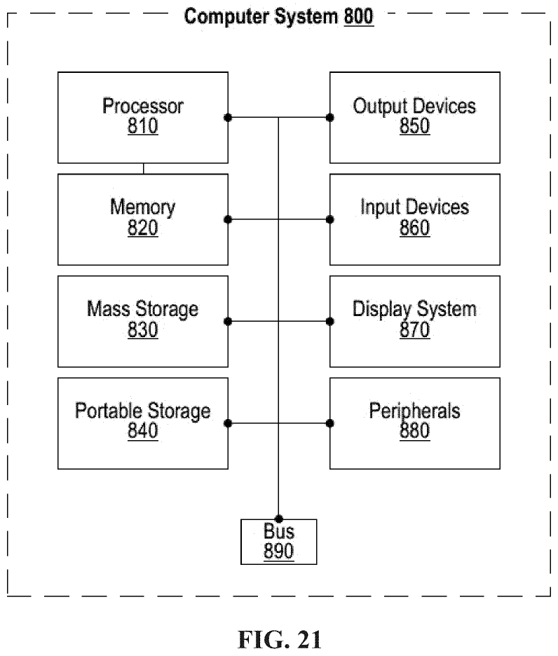

FIG. 21 illustrates a network environment through which different types of client devices participate in transfers via a distributed blockchain ledger.

There may be minor differences between the different client devices 110, such as firmware, firmware version, operating system, operating system version, hardware, hardware version, or combinations thereof. For example, different client devices might include hard drives or flash memory chips with subtly or widely different storage capabilities. Other client devices 110 might include faster processor(s) or additional cores. Certain client devices 110 might include additional hardware that might be missing from other client devices 110.

Four client devices 110 are illustrated in FIG. 21, including a client device 110J that is a laptop computer, a client device 110K that is a home video game console, a client device 110L that is a desktop computer, and a client device 110M that is a portable device/mobile device such as a smartphone, a tablet computing device, a media player device, a portable video game console, a wearable device, or a combination thereof. The client devices 110 of FIG. 21 can communicate directly or via network hardware 105.

The client devices 110 of FIG. 21 can run distributed blockchain ledgers. This is particularly useful if the data is released on multiple platforms (types of computing device) or is ported from one platform (type of computing device) to one or more other platforms (types of computing device).

Use of a variety of client devices 110 may be useful to help ease the burden by allowing remote server(s) to take on some of the work of verifying transactions and generating blocks if needed. This can be particularly useful at launch to make sure that transactions can be verified in a timely manner even for the first few attempted transactions using the blockchain ledger.

FIG. 22 illustrates a computing system 800 that may be used to implement some aspects of the subject technology. For example, any of the computing devices, computing systems, network devices, network systems, servers, and/or arrangements of circuitry described herein may include at least one computing system 800, or may include at least one component of the computer system 800 identified in FIG. 22. The computing system 800 of FIG. 22 includes one or more processors 810 and memory 820. Each of the processor(s) 810 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 810 may include one or more cores, either integrated onto a single chip or spread across multiple chips connected or coupled together. Memory 820 stores, in part, instructions and data for execution by processor 810. Memory 820 can store the executable code when in operation. The system 800 of FIG. 22 further includes a mass storage device 830, portable storage medium drive(s) 840, output devices 850, user input devices 860, a graphics display 880, and peripheral devices 880.

The components shown in FIG. 22 are depicted as being connected via a single bus 890. However, the components may be connected through one or more data transport means. For example, processor unit 810 and memory 820 may be connected via a local microprocessor bus, and the mass storage device 830, peripheral device(s) 880, portable storage device 840, and display system 880 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing some aspects of the subject technology for purposes of loading that software into memory 820.

Portable storage device 840 operates in conjunction with a portable non-volatile storage medium, such as a floppy disk, compact disk or Digital video disc, to input and output data and code to and from the computer system 800 of FIG. 22. The system software for implementing aspects of the subject technology may be stored on such a portable medium and input to the computer system 800 via the portable storage device 840.

The memory 820, mass storage device 830, or portable storage 840 may in some cases store sensitive information, such as transaction information, health information, or cryptographic keys, and may in some cases encrypt or decrypt such information with the aid of the processor 810. The memory 820, mass storage device 830, or portable storage 840 may in some cases store, at least in part, instructions, executable code, or other data for execution or processing by the processor 810.

Output devices 850 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 880. The printer may be inkjet, laserjet, thermal, or some combination thereof. In some cases, the output device circuitry 850 may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, a radio-frequency identification (RFID) wireless signal transfer, near-field communications (NFC) wireless signal transfer, 802.11 Wi-Fi wireless signal transfer, cellular data network wireless signal transfer, a radio wave signal transfer, a microwave signal transfer, an infrared signal transfer, a visible light signal transfer, an ultraviolet signal transfer, a wireless signal transfer along the electromagnetic spectrum, or some combination thereof. Output devices 850 may include any ports, plugs, antennae, or any other components necessary for the communication types listed above, such as cellular Subscriber Identity Module (SIM) cards.

Input devices 860 may include circuitry providing a portion of a user interface. Input devices 860 may include an alpha-numeric keypad, such as a keyboard, for inputting alpha-numeric and other information, or a pointing device, such as a mouse, a trackball, stylus, or cursor direction keys. Input devices 860 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, a radio-frequency identification (RFID) wireless signal transfer, near-field communications (NFC) wireless signal transfer, 802.11 Wi-Fi wireless signal transfer, cellular data network wireless signal transfer, a radio wave signal transfer, a microwave signal transfer, an infrared signal transfer, a visible light signal transfer, an ultraviolet signal transfer, a wireless signal transfer along the electromagnetic spectrum, or some combination thereof. Input devices 860 may include any ports, plugs, antennae, or any other components necessary for the communication types listed above, such as cellular SIM cards.

Display system 880 may include a liquid crystal display (LCD), a plasma display, an organic light-emitting diode (OLED) display, an electronic ink or “e-paper” display, a projector-based display, a holographic display, or another suitable display device. Display system 880 receives textual and graphical information, and processes the information for output to the display device. The display system 880 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 880 may include any type of computer support device to add additional functionality to the computer system. For example, peripheral device(s) 880 may include a modem, a router, an antenna, a printer, a bar code scanner, a quick-response (“QR”) code scanner, a document/image scanner, a visible light camera, a thermal/infrared camera, an ultraviolet-sensitive camera, a night vision camera, a light sensor, a battery, a power source, or some combination thereof.

The components contained in the computer system 800 of FIG. 22 are those typically found in computer systems that may be suitable for use with some aspects of the subject technology and are intended to represent a broad category of such computer components that are well known in the art. Thus, the computer system 800 of FIG. 22 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer system 800 may in some cases be a virtual computer system executed by another computer system. The computer can also include different bus configurations, networked platforms, multi-processor platforms, etc. Various operating systems can be used including Unix, Linux, Windows, Macintosh OS, Palm OS, Android, iOS, and other suitable operating systems.

In some cases, the computer system 800 may be part of a multi-computer system that uses multiple computer systems 800, each for one or more specific tasks or purposes. For example, the multi-computer system may include multiple computer systems 800 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 800 from different networks communicatively coupled together via the internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 820, the mass storage 830, the portable storage 840, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay®/Mastercard®/Visa® (EMV) chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L8), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 810 for execution. A bus 890 carries the data to system RAM or another memory 820, from which a processor 810 retrieves and executes the instructions. The instructions received by system RAM or another memory 820 can optionally be stored on a fixed disk (mass storage device 830/portable storage 840) either before or after execution by processor 810. Various forms of storage may likewise be implemented as well as the necessary network interfaces and network topologies to implement the same.

The disclosed single-entry, multi-functionality system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form. As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couples the processor to the network interface device. The interface can include one or more of a modem or network interface. It will be appreciated that a modem or network interface can be considered to be part of the computer system. The interface can include an analog modem, Integrated Services Digital network (ISDNO modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
storing a distributed ledger within a distributed architecture having a plurality of nodes, wherein the distributed ledger includes a plurality of blocks, wherein a complete copy of the distributed ledger is stored on one or more nodes within the plurality of nodes, and wherein the distributed ledger is capable of verifying the plurality of blocks;
providing a credential request, wherein the credential request includes information that when received at a first node can be used to perform a credential lookup;
receiving a verified, issued credential when the credential lookup is successful, wherein the issued credential is verified when the issued credential is issued;
receiving a request for a proof;
generating a zero knowledge proof, wherein the zero knowledge proof is generated using the verified, issued credential; and
providing the zero knowledge proof, wherein when the zero knowledge proof is received at a second node, the zero knowledge proof can be used to verify a criteria.

2. The computer-implemented method of claim 1, wherein the first node and the second node are the same node.

3. The computer-implemented method of claim 1, wherein the first node is an authorized node by the second node to issue credentials.

4. The computer-implemented method of claim 1, wherein the credential lookup is for a business identification verification, a credit score verification, or a license verification.

5. The computer-implemented method of claim 1, further comprising adding a node to an authorized list for future transactions such that future verification of the node is unnecessary.

6. The computer-implemented method of claim 1, further comprising:
providing a request for a transaction to a merchant;
receiving an invoice based on the request for the transaction from the merchant;
confirming an intention to pay for the transaction with the second node based on the request;
providing a first payment to the merchant for the transaction; and
providing a second payment to the second node for the transaction.

7. The computer-implemented method of claim 1, further comprising:
providing a request for consumer information to multiple nodes;
receiving a response from the multiple nodes based on the request for consumer information;
generating an obligation to compensate for the consumer information based on the response from the multiple nodes; and
providing proof of the obligation to compensate for the consumer information to the multiple nodes.

8. A system comprising:
one or more processors; and
memory storing thereon instructions that, as a result of being executed by the one or more processors, cause the system to:
store a distributed ledger within a distributed architecture having a plurality of nodes, wherein the distributed ledger includes a plurality of blocks, wherein a complete copy of the distributed ledger is stored on one or more nodes within the plurality of nodes, and wherein the distributed ledger is capable of verifying the plurality of blocks;
provide a credential request, wherein the credential request includes information that when received at a first node can be used to perform a credential lookup;
receive a verified, issued credential when the credential lookup is successful, wherein the issued credential is verified when the issued credential is issued;
receive a request for a proof;
generate a zero knowledge proof, wherein the zero knowledge proof is generated using the verified, issued credential; and
provide the zero knowledge proof, wherein when the zero knowledge proof is received at a second node, the zero knowledge proof can be used to verify a criteria.

9. The system of claim 8, wherein the first node and the second node are the same node.

10. The system of claim 8, wherein the first node is an authorized node by the second node to issue credentials.

11. The system of claim 8, wherein the credential lookup is for a business identification verification, a credit score verification, or a license verification.

12. The system of claim 8, wherein the instructions further cause the system to add a node to an authorized list for future transactions such that future verification of the node is unnecessary.

13. The system of claim 8, wherein the instructions further cause the system to:
provide a request for a transaction to a merchant;
receive an invoice based on the request for the transaction from the merchant;
confirm an intention to pay for the transaction with the second node based on the request;
provide a first payment to the merchant for the transaction; and
provide a second payment to the second node for the transaction.

14. The system of claim 8, wherein the instructions further cause the system to:
provide a request for consumer information to multiple nodes;
receive a response from the multiple nodes based on the request for consumer information;
generate an obligation to compensate for the consumer information based on the response from the multiple nodes; and
provide proof of the obligation to compensate for the consumer information to the multiple nodes.

15. A non-transitory, computer-readable storage medium storing thereon executable instructions that, as a result of being executed by one or more processors of a computer system, cause the computer system to:
store a distributed ledger within a distributed architecture having a plurality of nodes, wherein the distributed ledger includes a plurality of blocks, wherein a complete copy of the distributed ledger is stored on one or more nodes within the plurality of nodes, and wherein the distributed ledger is capable of verifying the plurality of blocks;
provide a credential request, wherein the credential request includes information that when received at a first node can be used to perform a credential lookup;
receive a verified, issued credential when the credential lookup is successful, wherein the issued credential is verified when the issued credential is issued;
receive a request for a proof;
generate a zero knowledge proof, wherein the zero knowledge proof is generated using the verified, issued credential; and
provide the zero knowledge proof, wherein when the zero knowledge proof is received at a second node, the zero knowledge proof can be used to verify a criteria.

16. The non-transitory, computer-readable storage medium of claim 15, wherein the first node and the second node are the same node.

17. The non-transitory, computer-readable storage medium of claim 15, wherein the first node is an authorized node by the second node to issue credentials.

18. The non-transitory, computer-readable storage medium of claim 15, wherein the credential lookup is for a business identification verification, a credit score verification, or a license verification.

19. The non-transitory, computer-readable storage medium of claim 15, wherein the executable instructions further cause the computer system to add a node to an authorized list for future transactions such that future verification of the node is unnecessary.

20. The non-transitory, computer-readable storage medium of claim 15, wherein the executable instructions further cause the computer system to:
provide a request for a transaction to a merchant;
receive an invoice based on the request for the transaction from the merchant;
confirm an intention to pay for the transaction with the second node based on the request;
provide a first payment to the merchant for the transaction; and
provide a second payment to the second node for the transaction.
